(19) United States
(12) Patent Application Publication
(10) Pub. No.: US 2012/0176076 A1
(43) Pub. Date: Jul. 12, 2012

(54) Methods and systems for powering auxiliary devices in photovol taic system

(76) Inventors: Carl Mansfield, Camas, WA (US); Daniel J. Park, Beaverton, OR (US)

(21) Appl. No.: 12/930,539

(22) Filed: Jan. 10, 2011

(51) Int. Cl. H02J 7/32

(52) U.S. Cl. 320/101

(57) ABSTRACT

Methods and systems for powering auxiliary devices in photovoltaic (PV) systems address shortcomings of conventional PV systems by harvesting unused electricity generated by the PV system to power the auxiliary devices. The methods and systems use PV panel power that is below the PV system inverter's harvesting threshold to charge rechargeable batteries in the auxiliary devices. The invention offers significant advantages over conventional PV systems, including full-time operability of auxiliary devices by virtue of rechargeable batteries that are charged using below threshold PV panel power, reduced field maintenance requirements for auxiliary devices (e.g., battery pack replacement), and elimination of bias in PV system performance data caused by parasitic load of auxiliary devices.

### BACKGROUND OF THE INVENTION

This invention relates to photovoltaic (PV) systems and, more particularly, to powering auxiliary devices in a PV system.

PV systems typically include an array of PV panels that capture sunlight and convert it into direct current (DC) power, and an inverter that converts the DC power into alternating current (AC) power that is supplied to a power grid. PV systems also routinely include auxiliary devices at the PV system installation site. Such auxiliary devices may include, for example, PV system performance monitoring devices, environmental monitoring devices, data storage devices, wireless communication devices and communication infrastructure devices.

Auxiliary devices in a PV system are often powered by batteries that must be replaced. In a PV system having a large number of battery powered auxiliary devices, significant field maintenance issues arise. For example, each auxiliary device's battery pack must be individually swapped in the field and the device must be carefully resealed to protect against often harsh environmental conditions at the installation site. Moreover, if an auxiliary device's batteries drain before replacement, operability of the auxiliary device is temporarily lost.

These field maintenance issues can be alleviated by allowing auxiliary devices to draw power from the PV panels, rather than relying on batteries. However, using PV panels as the power source can render the auxiliary devices inoperative during periods of darkness, low light and/or snow coverage when PV panels generate little or no power. Moreover, having auxiliary devices draw power from PV panels can bias PV system performance data. For example, the parasitic load of an auxiliary device can result in performance data showing that a PV panel is producing less power than it is in fact, and reliance on biased performance data can lead to suboptimal business and technical decisions.

### SUMMARY OF THE INVENTION

The present invention, in a basic feature, addresses shortcomings of conventional PV systems by harvesting unused electricity generated by a PV system and using it to power the PV system's auxiliary devices. The invention takes advantage of the fact that inverters in PV systems have a harvesting threshold below which they do not harvest power generated by PV panels. Rather than discarding PV panel power that is below an inverter's harvesting threshold (e.g., power generated during periods of low light), the invention applies this below threshold PV panel power to charge rechargeable batteries in the PV system's auxiliary devices. The invention offers significant advantages over conventional PV systems, including: (1) full-time operability of auxiliary devices by virtue of rechargeable batteries that are charged using below threshold PV panel power, (2) reduced field maintenance requirements for auxiliary devices (e.g., battery pack replacement), and (3) elimination of bias in PV system performance data caused by parasitic load of auxiliary devices.

In one aspect of the invention, a PV system comprises a PV panel array having one or more PV panels adapted to generate PV panel power, an inverter operatively coupled with the PV panel array and adapted to harvest PV panel power, and one or more auxiliary devices operatively coupled with the PV panel array and having one or more rechargeable batteries, wherein the auxiliary devices continually determine whether the inverter is harvesting PV panel power, wherein when the auxiliary devices determine that the inverter is harvesting PV panel power the auxiliary devices prevent harvesting of PV panel power by the auxiliary devices, and wherein when the auxiliary devices determine that the inverter is not harvesting PV panel power the auxiliary devices allow harvesting of PV panel power whereby the rechargeable batteries are charged.

In some embodiments, the auxiliary devices determine whether the inverter is harvesting PV panel power at least in part by analyzing a DC voltage supplied by the PV panel array.

In some embodiments, the auxiliary devices determine whether the inverter is harvesting PV panel power at least in part by analyzing a DC current flowing to the inverter.

In some embodiments, the auxiliary devices determine whether the inverter is harvesting PV panel power at least in part by analyzing AC power supplied by the inverter.

In some embodiments, the auxiliary devices determine whether the inverter is harvesting PV panel power at least in part by analyzing an operating mode reading taken from the inverter.

In some embodiments, the auxiliary devices determine whether the inverter is harvesting PV panel power at least in part by analyzing a feedback signal indicative of whether the inverter is harvesting PV panel power.

In some embodiments, the auxiliary devices comprise one or more PV system performance monitoring devices.

In some embodiments, the inverter harvests PV panel power at least in part by converting DC power supplied by the PV panel array into AC power and supplying the AC power to a power grid.

In some embodiments, the auxiliary devices harvest PV panel power at least in part by using DC power supplied by the PV panel array to charge the rechargeable batteries.

In another aspect of the invention, an auxiliary device for a PV system comprises a processor, and a rechargeable battery operatively coupled with the processor, wherein the rechargeable battery is charged using PV panel power, and wherein the processor continually determines whether an inverter of the PV system is harvesting PV panel power and regulates use of PV panel power to charge the rechargeable battery based at least in part on whether the inverter is harvesting PV panel power.

In some embodiments, the processor prevents use of PV panel power to charge the rechargeable battery upon determining that the inverter is harvesting PV panel power.

In some embodiments, the processor allows use of PV panel power to charge the rechargeable battery upon determining that the inverter is not harvesting PV panel power.

In some embodiments, the determination comprises analyzing a DC voltage supplied by a PV panel.

In some embodiments, the determination comprises analyzing a DC current flowing to the inverter.

In some embodiments, the determination comprises analyzing AC power supplied by the inverter.

In some embodiments, the determination comprises analyzing an operating mode reading taken from the inverter.

In some embodiments, the determination comprises analyzing a feedback signal indicative of whether the inverter is harvesting PV panel power.

In some embodiments, the processor further regulates use of the PV panel power to charge the rechargeable battery based at least in part on a comparison of a charge on the rechargeable battery with a critical low charge threshold.

In some embodiments, the auxiliary device further comprises a wireless modem operatively coupled with the processor, and the processor receives via the wireless modem a feedback signal indicative of whether the inverter is harvesting PV panel power.

In some embodiments, the auxiliary device further comprises sensor logic and a power switch operatively coupled with the processor, and the processor determines a connection state for the power switch based at least in part on a reading of PV panel power taken by the sensor logic.

In some embodiments, the auxiliary device further comprises a wireless modem operatively coupled with the processor, and the processor reports via the wireless modem readings taken by the sensor logic.

In another aspect of the invention, a method for powering an auxiliary device in a PV system comprises the steps of continually determining by the auxiliary device whether an inverter of the PV system is harvesting PV panel power, and regulating use by the auxiliary device of the PV panel power to charge a rechargeable battery based at least in part on whether the inverter is harvesting PV panel power.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 is a block diagram of a PV system in some embodiments of the invention.

FIG. 2 is a block diagram of a PV performance monitoring device in some embodiments of the invention.

FIG. 3 is a state diagram showing conditions prompting transitions between a battery charging state and a battery not charging state in some embodiments of the invention, where AC power supplied by an inverter and a feedback signal are used.

FIG. 4 is a state diagram showing conditions prompting transitions between a battery charging state and a battery not charging state in some embodiments of the invention, where DC voltage supplied by a PV panel is used.

FIG. 5 is a state diagram showing conditions prompting transitions between a battery charging state and a battery not charging state in some embodiments of the invention, where DC current flowing to an inverter is used.

FIG. 6 is a flow diagram showing a method for handling a critical low battery charge condition in some embodiments of the invention.

### DETAILED DESCRIPTION OF A PREFERRED EMBODIMENT

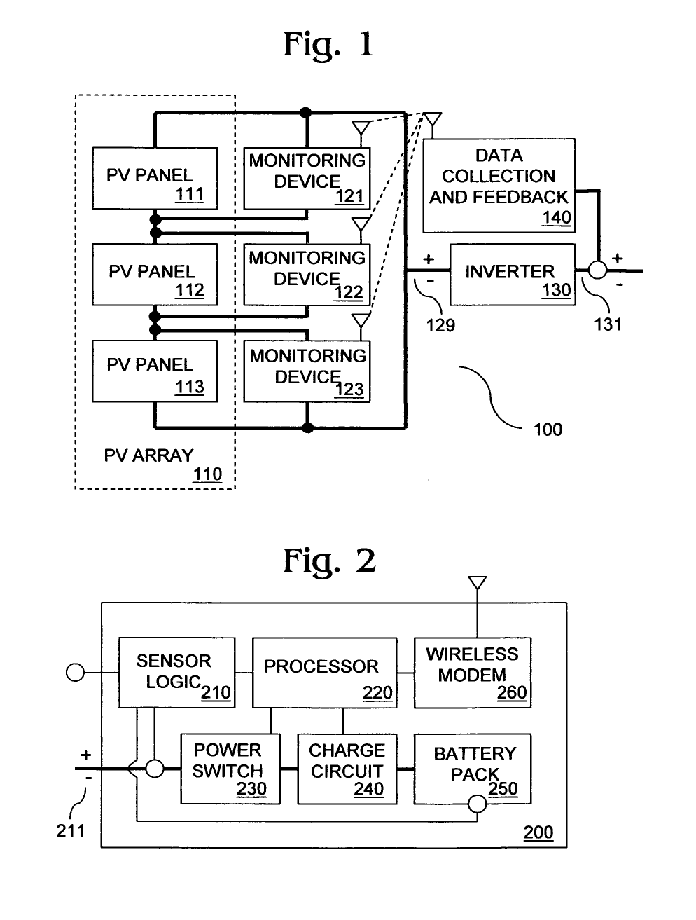

FIG. 1 shows a PV system 100 in some embodiments of the invention. PV system 100 includes a PV panel array 110 having a multiple of PV panels 111, 112, 113 coupled to an inverter 130 over power lines. PV panels 111, 112, 113 have respective monitoring devices 121, 122, 123 coupled thereto. Monitoring devices 121, 122, 123 are wirelessly coupled with a data collection and feedback system 140. Although monitoring devices 121, 122, 123 are shown directly coupled with data collection and feedback system 140 over a wireless link, devices 121, 122, 123 and system 140 may be separated by intervening communication nodes.

PV panels 111, 112, 113 capture incident sunlight, convert it to DC power and supply DC power to inverter 130 via inverter input terminals 129. The voltage of the DC power supplied by PV panels 111, 112, 113 is measured by monitoring devices 121, 122, 123, respectively. The DC power supplied to inverter 130 varies with incident sunlight. When incident sunlight is strong, such as at midday on a cloudless day, a relatively large DC power with a relatively high voltage level is supplied to inverter 130. When incident sunlight is weak, such as at dawn, dusk or a period of heavy cloud cover, a positive but relatively small DC power with a relatively low voltage level is supplied to inverter 130. When incident sunlight is absent, such as after dark or when PV array 110 is covered with snow, the DC power and voltage supplied to inverter 130 is near or at zero.

Inverter 130 converts DC power received from PV panel array 110 on inverter input terminals 129 into AC power and supplies the AC power on inverter output terminals 131 to a power grid. However, inverter 130 has an operating range and does not perform power conversions when the DC voltage on inverter input terminals 129 is below an inverter harvesting threshold. For example, inverter 130 may have an operating range of 240 to 550 volts and require a minimum 235 volt DC input before attempting conversion to a 240 volt AC output to the power grid. Accordingly, a DC voltage on inverter input terminals 129 that does not reach the inverter harvesting threshold does not enable inverter 130 to contribute to grid power.

Monitoring devices 121, 122, 123 are auxiliary devices of PV system 100 that run on rechargeable batteries. In illustrated embodiments, monitoring devices 121, 122, 123 are assigned to monitor PV panels 111, 112, 113, respectively. Monitoring devices 121, 122, 123 measure DC voltage supplied by the PV panel to which they are assigned and may also measure DC current flowing to inverter 130. In other embodiments, a monitoring device may be assigned to monitor multiple PV panels or even an entire array of PV panels. Monitoring devices 121, 122, 123 continually monitor and report to data collection and feedback system 140 on PV panel performance and environmental conditions at the installation site.

Monitoring devices 121, 122, 123 continually assess whether inverter 130 is harvesting PV panel power to determine when to charge their rechargeable batteries. When monitoring devices 121, 122, 123 determine that inverter 130 is harvesting PV panel power, monitoring devices 121, 122, 123 refrain from charging their batteries so as not to impose a parasitic load on PV system 100 that reduces grid power and biases PV panel performance metrics. On the other hand, when monitoring devices 121, 122, 123 determine that inverter 130 is not harvesting PV panel power, monitoring devices 121, 122, 123, except in special circumstances, charge their batteries so as to extend the operating life of monitoring devices 121, 122, 123 without the need for field maintenance.

Turning to FIG. 2, a PV performance monitoring device 200 is shown in some embodiments of the invention. Monitoring device 200 is representative of monitoring devices 121, 122, 123 shown in FIG. 1. Monitoring device 200 has sensor logic 210, a power switch 230, a charge circuit 240 and a wireless modem 260, all of which are communicatively coupled with a processor 220. Charge circuit 240 is operatively coupled between power switch 230 and a rechargeable battery pack 250.

Sensor logic 210 continually measures the DC voltage supplied by the PV panel to which monitoring device 200 has been assigned on PV panel output terminals 211. Sensor logic 210 may also continually measure the DC current flowing to inverter 130, environmental conditions (e.g., air temperature), and the charge on battery pack 250. Readings taken by sensor logic 210 are fed to processor 220 for local analysis and storage on monitoring device 200 and are periodically transmitted to data collection and feedback system 140 via a wireless modem 260 for remote analysis and storage.

Power switch 230, under direction of processor 220, conditionally isolates charge circuit 240 and battery pack 250 from the DC voltage supplied on PV panel output terminals 211. When processor 220 determines that inverter 130 is harvesting PV panel power, processor 220 disconnects power switch 230 which inhibits the supply of DC power to charge circuit 240 and battery pack 250. On the other hand, when processor 220 determines that inverter 130 is not harvesting PV panel power, processor 220 connects power switch 230 which supplies DC power to charge circuit 240 and battery pack 250. An exception arises when the DC voltage supplied on PV panel output terminals 211 is below a monitoring device harvesting voltage threshold, in which case power switch 230 generally remains disconnected even though inverter 130 is not harvesting PV panel power. Power switch 230 may be implemented in transistor circuits using MOSFETs or in reed switches with bi-stable hysteresis.

Charge circuit 240, depending on the connection state of power switch 230, conditionally charges battery pack 250 using DC power supplied on PV panel output terminals 211. When power switch 230 is connected, charge circuit 240 charges battery pack 250 unless battery pack 250 is fully charged. On the other hand, when power switch 230 is disconnected, charge circuit 240 does not charge battery pack 250. Charge circuit 240 is a passive circuit that does not depend on power from battery pack 250 in order to perform its battery charging function.

Battery pack 250 is a factory sealed pack and has one or more batteries. By way of example, the batteries in battery pack 250 may be nickel metal hydride (NiMH), nickel cadmium (NiCd), nickel zinc (NiZn), lead acid or lithium ion (Li-ion) batteries and may be size AA, AAA, C, D or 9 Volt.

Wireless modem 260 is a bidirectional wireless communication interface that transmits and receives data to and from data collection and feedback system 140. Wireless modem 260 may implement one or more standard wireless communication protocols, such as wireless Ethernet (WiFi), ZigBee wireless mesh networking, Worldwide Interoperability for Microwave Access (WiMAX), Code Division Multiple Access (CDMA), Global System for Mobile Communication (GSM) and/or Universal Mobile Telecommunications System (UMTS).

Monitoring devices 121, 122, 123 may determine whether inverter 130 is harvesting PV panel power in several ways. In some embodiments, monitoring devices 121, 122, 123 determine whether inverter 130 is harvesting PV panel power by analyzing a feedback signal indicative of whether inverter 130 is harvesting PV panel power. In some of these embodiments, data collection and feedback system 140 continually measures AC power supplied by inverter 130 on inverter output terminals 131 and determines when the power flow is towards the power grid. When the AC power is flowing into the power grid, system 140 presumes that inverter 130 is harvesting PV panel power and transmits to monitoring devices 121, 122, 123 a feedback signal indicating that inverter 130 is harvesting PV panel power. On the other hand, when the AC power is not flowing towards the power grid, system 140 presumes that inverter 130 is not harvesting PV panel power and transmits to monitoring devices 121, 122, 123 a feedback signal indicating that inverter 130 is not harvesting PV panel power. In other of these embodiments, data collection and feedback system 140 communicates directly with inverter 130 and continually reads the operating mode of inverter 130, then transmits to monitoring devices 121, 122, 123 a feedback signal indicating whether inverter 130 is harvesting PV panel power.

FIG. 3 is a state diagram showing conditions prompting transitions by representative monitoring device 200 between a battery charging state 320 and a battery not charging state 310 in embodiments where AC power supplied by inverter 130 or inverter operating mode readings and a feedback signal are used by monitoring device 200 to determine whether inverter 130 is harvesting power. Assume battery pack 250 is in the battery not charging state 310 and processor 220 receives from system 140 via wireless modem 260 a feedback signal indicating that inverter 130 is not harvesting PV panel power (−FEEDBACK). Provided that the DC voltage supplied on PV panel output terminals 211 is above a harvesting threshold for monitoring device 200 (V>V_{M}) and battery pack 250 is not fully charged, processor 220 connects power switch 230 and monitoring device 200 enters the battery charging state 320 wherein battery pack 250 starts charging. When processor 220 later receives from system 140 via wireless modem 260 a feedback signal indicating that inverter 130 is harvesting PV panel power (+FEEDBACK), or the DC voltage supplied on PV panel output terminals 211 is below the harvesting threshold for monitoring device 200 (V<V_{M}) or battery pack 250 is fully charged, processor 220 disconnects power switch 230 and monitoring device 200 reenters the battery not charging state 310 wherein battery pack 250 stops charging.

In some embodiments, monitoring devices 121, 122, 123 determine whether inverter 130 is harvesting PV panel power by analyzing DC voltage supplied by PV panels 111, 112, 113. In these embodiments, monitoring devices 121, 122, 123 continually and individually measure DC voltage supplied by PV panels 111, 112, 113 that monitoring devices 121, 122, 123 have been assigned to monitor on PV panel output terminals (e.g., 211) and compare the DC voltage with individual thresholds configured on monitoring devices 121, 122, 123. These thresholds are set based on system design and configuration and/or empirical studies to levels above which harvesting of PV panel power by inverter 130 can be presumed. Different ones of monitoring devices 121, 122, 123 may utilize the same or different thresholds. When a given one of monitoring devices 121, 122, 123 determines that the DC voltage supplied by its assigned PV panel is above its threshold, that monitoring device presumes inverter 130 is harvesting PV panel power. On the other hand, when a given one of monitoring devices 121, 122, 123 determines that the DC voltage supplied by its assigned PV panel is below its threshold, that monitoring device presumes inverter 130 is not harvesting PV panel power.

FIG. 4 is a state diagram showing conditions prompting transitions by monitoring device 200 between a battery charging state 420 and a battery not charging state 410 in embodiments where the DC voltage supplied by its assigned PV panel is used by monitoring device 200 to determine whether inverter 130 is harvesting power. Assume battery pack 250 is in the battery not charging state 410 and processor 220 receives from sensor logic 210 a reading of PV panel voltage taken on PV panel output terminals 211 that is above a harvesting threshold for monitoring device 200 (V>V_{M}) but below the presumed harvesting threshold for inverter 130 (V<V_{I}) configured on monitoring device 200. Provided that battery pack 250 is not fully charged, processor 220 connects power switch 230 and battery pack 250 enters the battery charging state 420 wherein battery pack 250 begins charging. When processor 220 later learns from sensor logic 210 that the PV panel voltage is above the presumed harvesting threshold for inverter 130 (V>V_{I}) or below the harvesting threshold for monitoring device 200 (V<V_{M}) or that battery pack 250 is fully charged, processor 220 disconnects power switch 230 whereby battery pack 250 returns to the battery not charging state 410 and stops charging.

In some embodiments, monitoring devices 121, 122, 123 determine whether inverter 130 is harvesting PV panel power by analyzing DC current flowing to inverter 130. In these embodiments, monitoring devices 121, 122, 123 continually and individually measure DC current flowing to inverter 130 and compare the DC current with a threshold. The threshold is set based on system design and configuration and/or empirical studies to a level above which harvesting of PV panel power by inverter 130 can be presumed. When a given one of monitoring devices 121, 122, 123 determines that DC current flowing to inverter 130 is above the threshold, that monitoring device presumes that inverter 130 is harvesting PV panel power. On the other hand, when a given one of monitoring devices 121, 122, 123 determines that DC current flowing to inverter 130 is below threshold, that monitoring device presumes that inverter 130 is not harvesting PV panel power.

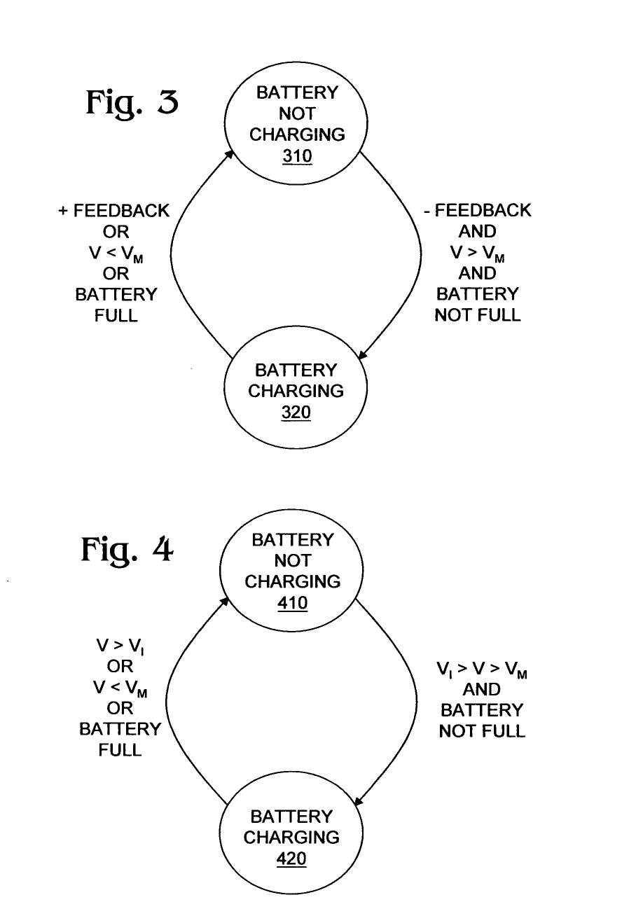

FIG. 5 is a state diagram showing conditions prompting transitions by monitoring device 200 between a battery charging state 520 and a battery not charging state 510 in embodiments where DC current flowing to inverter 130 is used by monitoring device 200 to determine whether inverter 130 is harvesting power. Assume battery pack 250 is in the battery not charging state 510 and processor 220 receives from sensor logic 210 a reading of DC current flowing to inverter 130 (e.g., on one of PV panel output terminals 211) that is below the harvesting threshold for inverter 130 (I<I_{I}) and a reading of PV panel voltage taken on PV panel output terminals 211 that is above a harvesting threshold for monitoring device (V>V_{M}). Provided that battery pack 250 is not fully charged, processor 220 connects power switch 230 and monitoring device 200 enters the battery charging state 520 wherein battery pack 250 begins charging. When processor 220 later learns from sensor logic 210 that the DC current flowing to inverter 130 is above the harvesting threshold for inverter 130 (I>I_{I}) or that the PV panel voltage is below the threshold for monitoring device 200 (V<V_{M}) or that battery pack 250 is fully charged, processor 220 disconnects power switch 230 and monitoring device 200 returns to the battery not charging state 510 wherein battery pack 250 stops charging.

In some embodiments, monitoring devices 121, 122, 123 invoke two or more of the above methods to determine whether inverter 130 is harvesting PV panel power. For example, inverter 130 may be presumed to be harvesting PV panel power if two or more of the invoked methods indicate that inverter 130 is harvesting PV panel power.

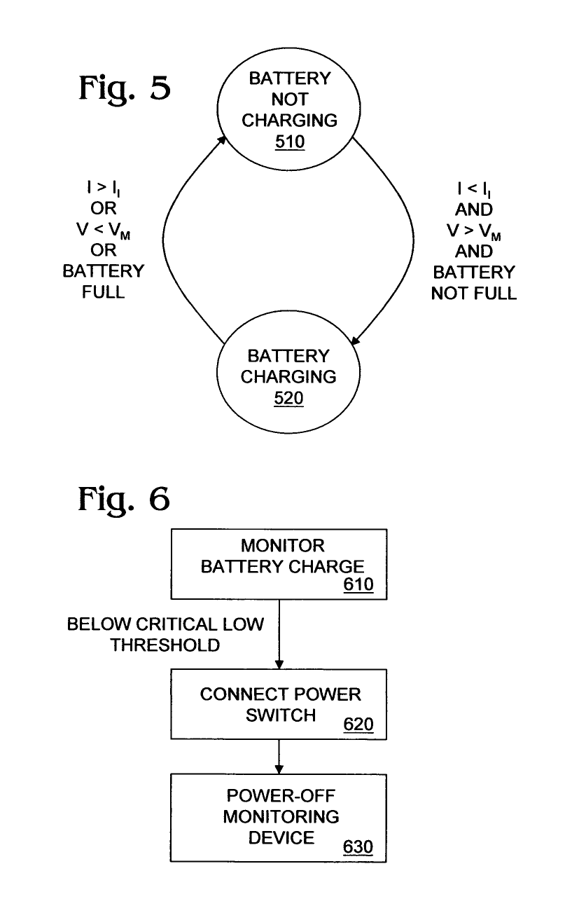

FIG. 6 is a flow diagram showing a method for handling a critical low battery charge condition in some embodiments of the invention. In the event a PV panel fails to generate power for an extended period (e.g., due to snow coverage) and the battery of the monitoring device assigned to the PV panel battery becomes nearly drained, execution of this method by the monitoring device can enable it to resume normal operation once the PV panel starts generating power. Taking FIG. 2 in conjunction with FIG. 6, sensor logic 210 continually monitors the charge on battery pack 250 and reports readings to processor 220 (610). When processor 220 receives from sensor logic 210 a reading indicating that the charge on battery pack 250 is critically low, processor 220 connects power switch 230 (620) and powers-off monitoring device 200 (630). Connecting power switch 230 prior to shut-down enables charge circuit 240 to automatically resume its essential battery charging function when the PV panel assigned to monitoring device 200 starts generating DC voltage and activate processor 220 once battery pack 250 acquires sufficient charge.

It will be appreciated by those of ordinary skill in the art that the invention can be embodied in other specific forms without departing from the spirit or essential character hereof. For example, while embodiments have been described in which the auxiliary devices that harvest and run on unused PV panel power are PV performance monitoring devices, other types of auxiliary devices, such as environmental monitoring devices, data storage devices, wireless communication devices and communication infrastructure devices may harvest and run on unused PV panel power. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A photovoltaic (PV) system, comprising:
a PV panel array having one or more PV panels adapted to generate PV panel power;
an inverter operatively coupled with the PV panel array and adapted to harvest PV panel power; and
one or more auxiliary devices operatively coupled with the PV panel array and having one or more rechargeable batteries, wherein the auxiliary devices continually determine whether the inverter is harvesting PV panel power, wherein when the auxiliary devices determine that the inverter is harvesting PV panel power the auxiliary devices prevent harvesting of PV panel power by the auxiliary devices, and wherein when the auxiliary devices determine that the inverter is not harvesting PV panel power the auxiliary devices allow harvesting of PV panel power whereby the rechargeable batteries are charged.

2. The PV system of claim 1, wherein the auxiliary devices determine whether the inverter is harvesting PV panel power at least in part by analyzing a DC voltage supplied by the PV panel array.

3. The PV system of claim 1, wherein the auxiliary devices determine whether the inverter is harvesting PV panel power at least in part by analyzing a DC current flowing to the inverter.

4. The PV system of claim 1, wherein the auxiliary devices determine whether the inverter is harvesting PV panel power at least in part by analyzing AC power supplied by the inverter.

5. The PV system of claim 1, wherein the auxiliary devices determine whether the inverter is harvesting PV panel power at least in part by analyzing a feedback signal indicative of whether the inverter is harvesting PV panel power.

6. The PV system of claim 1, wherein the auxiliary devices comprise one or more PV system performance monitoring devices.

7. The PV system of claim 1, wherein the inverter harvests PV panel power at least in part by converting DC voltage supplied by the PV panel array into AC voltage and supplying the AC voltage to a power grid.

8. The PV system of claim 1, wherein the auxiliary devices harvest PV panel power at least in part by using DC voltage supplied by the PV panel array to charge the rechargeable batteries.

9. An auxiliary device for a PV system, comprising:
a processor; and
a rechargeable battery operatively coupled with the processor, wherein the rechargeable battery is charged using PV panel power, and wherein the processor continually determines whether an inverter of the PV system is harvesting PV panel power and regulates use of PV panel power to charge the rechargeable battery based at least in part on whether the inverter is harvesting PV panel power.

10. The auxiliary device of claim 9, wherein the processor prevents use of PV panel power to charge the rechargeable battery upon determining that the inverter is harvesting PV panel power.

11. The auxiliary device of claim 9, wherein the processor allows use of PV panel power to charge the rechargeable battery upon determining that the inverter is not harvesting PV panel power.

12. The auxiliary device of claim 9, wherein the determination comprises analyzing a DC voltage supplied by a PV panel.

13. The auxiliary device of claim 9, wherein the determination comprises analyzing a DC current flowing to the inverter.

14. The auxiliary device of claim 9, wherein the determination comprises analyzing AC power supplied by the inverter.

15. The auxiliary device of claim 9, wherein the determination comprises analyzing a feedback signal indicative of whether the inverter is harvesting PV panel power.

16. The auxiliary device of claim 9, wherein the processor further regulates use of the PV panel power to charge the rechargeable battery based at least in part on a comparison of a charge on the rechargeable battery with a critical low charge threshold.

17. The auxiliary device of claim 9, further comprising a wireless modem operatively coupled with the processor, wherein the processor receives via the wireless modem a feedback signal indicative of whether the inverter is harvesting PV panel power.

18. The auxiliary device of claim 9, further comprising sensor logic and a power switch operatively coupled with the processor, wherein the processor determines a connection state for the power switch based at least in part on a reading of PV panel power taken by the sensor logic.

19. The auxiliary device of claim 9, further comprising a wireless modem operatively coupled with the processor, wherein the processor reports via the wireless modem readings taken by the sensor logic.

20. A method for powering an auxiliary device in a PV system, comprising the steps of:
continually determining by the auxiliary device whether an inverter of the PV system is harvesting PV panel power; and
regulating use by the auxiliary device of the PV panel power to charge a rechargeable battery based at least in part on whether the inverter is harvesting PV panel power.
